(19) United States
(12) Patent Application Publication
(10) Pub. No.: US 2010/0262349 A1
(43) Pub. Date: Oct. 14, 2010

(54) HILLHOLDER ASSISTANCE SYSTEM HAVING A VARIABLE CONDITION FOR RELEASING THE BRAKE

(76) Inventor: Toni Braeuer, Suzhou/Industrial Park (CN)

Correspondence Address: KENYON & KENYON LLP, ONE BROADWAY, NEW YORK, NY, 10004, US

(21) Appl. No.: 12/733,840

(22) PCT Filed: Sep. 19, 2008
(86) PCT No.: PCT/EP2008/062545

§ 371 Date: Jun. 23, 2010

(30) Foreign Application Priority Data
Sep. 27, 2007 (DE) 10 2007 046 307.5

(51) Int. Cl. B60W 10/18; B60W 30/18; G06F 19/00

(52) U.S. Cl. 701/70; 477/199

(57) ABSTRACT

In a method for assisting a driver during a hill start, the vehicle is held automatically at a standstill using a brake, and when a starting command is detected, the brake is released automatically if the engine torque or an equivalent variable exceeds a specified release threshold value. The vehicle is able to be prevented from rolling back, when the brake is released, by monitoring the engine torque or the equivalent variable for a change which is not due to the actuation of the accelerator, and by modifying the condition for releasing the brake when a change in the engine torque or in the equivalent variable has been detected.

### BACKGROUND OF THE INVENTION

1. Field of the Invention

The present invention relates to a method and a device for assisting a driver during a hill start.

2. Description of Related Art

Driver assistants, which are also often designated as hillholders, are used to assist a driver during a hill start. For this purpose, during standstill of the vehicle, the brake pressure in at least one wheel brake is locked in by automatically closing the valves of the braking system. When a starting command is detected, the brake pressure is automatically released, so that the vehicle is able to start. As a condition for releasing the brake, it is usually specified that the engine torque of the internal combustion engine has to exceed a certain starting torque. The starting torque, in this context, is that torque which has to be applied to compensate for the downgrade force and to move the vehicle forward.

A hillholder assistance system is known from published German patent document DE 19950034A1, which automatically releases the brake pressure locked in at the wheel if the engine torque exceeds the starting torque.

During a standstill of the vehicle, electrical consumers, such as the seat heating, the air conditioning system, etc., are sometimes switched on, or the driver operates the steering system, for example. This has the result that the engine control unit increases the engine torque and the engine speed, in order to provide the additional electric power. As a result, it may happen that the condition mentioned, for releasing the brake, is reached too early, even before the drive torque required for starting is achieved at the wheels. The vehicle therefore rolls backwards after the release of the brake, whereupon the driver would presumably operate the brake again.

### BRIEF SUMMARY OF THE INVENTION

It is therefore an object of the present invention to create an hillholder assistance system that works even when electrical consumers are switched on at a standstill of the vehicle.

One important aspect of the present invention is monitoring (directly or indirectly) the change in the engine torque or a variable equivalent to it, such as the engine speed, and to adjust the condition for releasing the brake when a change is detected that is not based on an operation of the accelerator. According to the present invention, the release condition is that the engine torque or its equivalent variable exceeds a specified threshold value. The release condition is now adjusted in such a way that the brake is released only when the drive torque, that is available at the wheels, compensates for the downgrade force and the vehicle does not roll backwards when the brake is released.

To adjust the condition, one may optionally increase the threshold value and/or reduce the engine torque, drawn upon for the comparison, by a certain amount. In both cases, the engine torque (or the equivalent variable) and the comparison engine torque reach the threshold value later, and the brake is not released until later.

At a standstill of the vehicle, the engine torque and the engine speed may be ascertained using a suitable sensing system. These variables are usually available in an engine control unit, and may be queried from the latter. The operation of the accelerator may be measured using a accelerator sensor, for example.

The engine torque and the engine speed may alternatively also be monitored indirectly, by monitoring the switching on or the switching off of an electric consumer. When an electrical consumer, such as a servomotor or an assembly of an air conditioning system, is switched on or off, the engine control unit automatically increases or reduces the engine speed, respectively. The switching on or off of certain consumers thus leads to a change in the engine torque, which is able to be determined indirectly by monitoring the operating state of the electric consumer.

The switching on or off of an electric consumer may be monitored, for instance, by measuring the power, the current or the voltage by checking an associated switch, evaluating information that is available in a bus system or in another manner.

According to one example embodiment of the present invention, the steering angle is monitored and the release condition of the hillholder assistance system is adjusted if the steering angle or its change exceeds a specified threshold value. If the driver moves the steering wheel at a standstill of the vehicle, the servomotor of the steering system becomes active. The engine control unit then automatically increases the engine speed in order to take care of the servomotor. Consequently, from the change in the steering angle one may conclude that there has been a change in the engine torque.

The quantitative adaptation of the release condition is preferably a function of the height of the electric power of the consumer. According to one preferred specific embodiment of the present invention, the threshold value is increased to the same extent as the increase in the engine torque caused by the switching on.

The release condition is preferably only adapted if the power of the electric consumer or the change in the engine torque, conditioned by the switching on, is greater than a specified threshold value. Relevant consumers, in particular, are assemblies of air conditioning systems, the electric motor of a power steering system or actuators of other vehicle systems, such as consumers having a power consumption of at least 50 W, for example.

A hillholder assistant according to the present invention essentially includes a control unit having an algorithm 7, which is designed to actuate an actuator of the braking system in such a way that the vehicle is automatically held, and which automatically releases the brake when a start command is detected, on the condition that the engine torque, or a variable proportional to it, exceeds a specified threshold value. The algorithm in this context is designed in such a way that, when an electric consumer is switched on, which leads to an automatic increase in the engine torque, the condition for releasing the brake is adjusted correspondingly.

### BRIEF DESCRIPTION OF THE SEVERAL VIEWS OF THE DRAWING

FIG. 1 shows a schematic block diagram of an hillholder assistance system.

FIG. 2 shows the curve of various characteristics variables during a starting process without adjusting the release condition.

FIG. 3 shows the curve of various characteristics variables during a starting process having adjustment of the condition for releasing the brake.

### DETAILED DESCRIPTION OF THE INVENTION

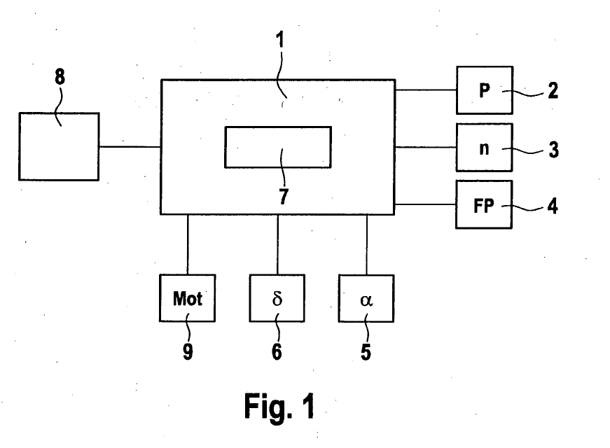

FIG. 1 shows a schematic block diagram of an hillholder assistance system, including a control unit 1 having an algorithm 7, which controls the locking in of the pressure at wheel brakes 8 and the release of wheel brakes 8. Control unit 1 is connected to various sensors 2-6, which are used to monitor the driving state. Consequently, the algorithm is in a position to detect a driving situation in which the vehicle has come to a standstill on a hill, or a situation in which the brake is to be released again.

In this exemplary embodiment, algorithm 7 is designed so that the brake pressure is locked in at least one wheel brake 8 if the vehicle is at a standstill, the hill of the lane is greater than a specified threshold value and the foot brake is actuated at the same time. The standstill of the vehicle may be measured, for instance, using rotational speed sensors 3 or may be estimated otherwise. A pedal sensor 2 is provided for detecting an actuation of the foot brake pedal. An actuation of the foot brake pedal could optionally also be detected by monitoring the brake pressure (driver admission pressure). An inclination sensor 5 is provided for determining the grade of the road. However, the grade of the road could also be estimated in a known manner from other variables.

Additional conditions may be specified for triggering the hillholder assistant, such as that the internal combustion engine of the vehicle has to be running, that a gear has to be engaged or that the accelerator may not be actuated, etc. If the specified activation conditions are fulfilled, algorithm 7 actuates one or more valves of braking system 8, in order to lock in the brake pressure at least one of the wheels and to hold it there automatically. If the braking pressure exerted by the driver is too low, it may be increased additionally, if necessary.

The hillholder assistant is deactivated and the brake is released when a start command of the driver is detected. Various conditions may be specified for this, in turn. In the present exemplary embodiment, the hillholder assistant is deactivated when the driver actuates the accelerator and the engine torque is greater than a specified threshold value. This threshold value is preferably selected so that the vehicle does not roll back when the brake is released.

The driver's start command is recorded via an accelerator sensor 4. The engine torque is provided by an engine control unit 9, which is connected to control unit 1. The starting torque is able to be calculated by knowing the vehicle mass and the grade of the road, or it may optionally be estimated from other variables. This estimation is sufficiently well known from the related art.

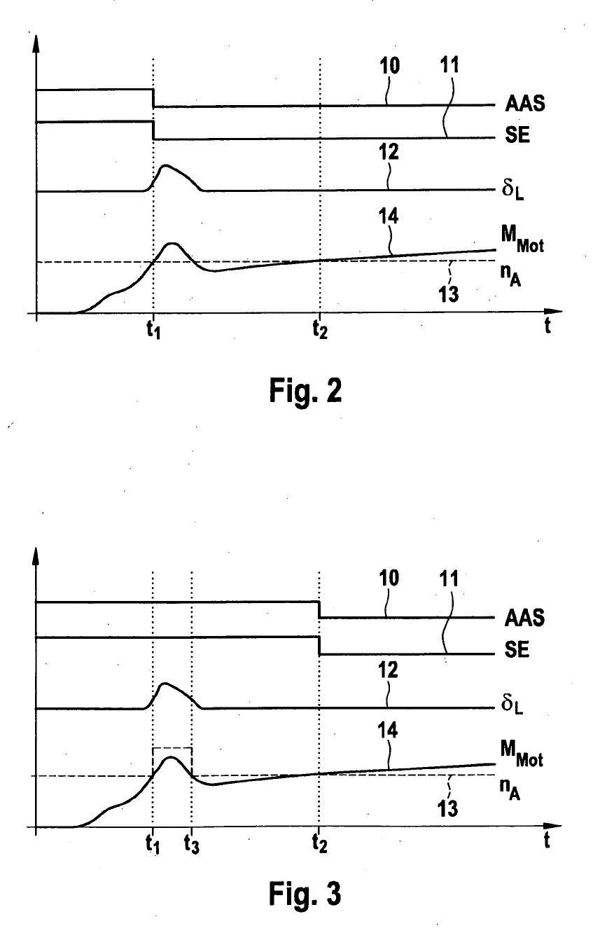

FIG. 2a shows the curve over time of various characteristics variables in a starting process. Characteristics curve 10 designates the state (active/deactivated) of the hillholder assistant, and characteristics curve 11 designates the standstill of the vehicle (standstill/traveling), in this context. The curve of steering angle δ_{L} is designated by 12, calculated starting torque n_{A} is designated by 13 and engine torque M_{Mot} is designated by 14.

At the beginning of the process, the hillholder assistant is active (characteristics curve 10 is high) and the vehicle is at a standstill (characteristics curve 11 is high). A starting process then begins, in which the driver increasingly actuates the accelerator, as may be seen from characteristics curve 14. The driver also actuates the steering wheel (see characteristics curve 12). The motion at the steering wheel is assisted in a known manner by a servomotor. This has the result that engine control unit 9 slightly increases the engine's rotational speed in order to provide a greater power for operating the servomotor. Therefore, characteristics curve 14 demonstrates an overshoot that is based on the switching on of the servomotor.

Engine torque 14 already exceeds starting torque 13 at time t₁, that is, substantially earlier than without steering wheel actuation (time t₂). This being the case, the hillholder assistant is deactivated already at time t₁ (see characteristics curve 10). Since the drive torque available at the wheels at time t₁ is not yet sufficient to compensate for the downgrade force, the vehicle will roll back.

FIG. 3 shows the curve over time of the characteristics variables during a starting process, during which the additional increase in engine torque 14, based on the switching on of the servomotor, is taken into account. At the beginning of the process, the vehicle is again at a standstill (characteristics curve 11) and the hillholder assistant is active (characteristics curve 10). The driver actuates the steering system during the starting process. When the change in the steering angle exceeds a certain threshold, threshold value 13 is temporarily raised. In this context, this value corresponds to at least the additional increase in engine torque 14 based on the switching on of the servomotor.

At time t₁, engine torque 14 therefore does not exceed threshold value 13 The driver subsequently turns the steering wheel back into the initial position (see characteristics curve 12). At time t₃, steering angle 12 falls below a certain threshold, whereby threshold value 13 is reset to the original value again. Engine torque 14 subsequently increases further, and at time t₂ it exceeds threshold value 13. Thus, the brake is only released at time t₂. In this case, the vehicle moves forwards, since now sufficient drive torque is available to compensate for the downgrade force.

1-7. (canceled)

8. A method for assisting a driver of a vehicle when starting the vehicle facing uphill, comprising:
automatically actuating a brake to hold the vehicle at a standstill if the vehicle is detected to be at a standstill on a hill having a gradient exceeding a predetermined threshold;
upon detection of a start command for the vehicle, automatically releasing the brake if one of an engine torque or a selected variable substantially equivalent to the engine torque exceeds a specified release threshold value;
monitoring a change in the one of the engine torque or the selected substantially equivalent variable; and
upon detection of a change in the one of the engine torque or the selected substantially equivalent variable not based on the actuation of the accelerator, adjusting the release threshold value.

9. The method as recited in claim 8, wherein the change in the one of the engine torque or the selected substantially equivalent variable is monitored indirectly by monitoring the switching on of an electric consumer, and wherein the release threshold value is adjusted if an electric consumer has been switched on.

10. The method as recited in claim 8, wherein, if a change in the one of the engine torque or the selected substantially equivalent variable is detected, increasing the release threshold value.

11. The method as recited in claim 9, wherein the release threshold value is adjusted only if at least one of the power demand of the electric consumer and the change in the engine torque caused by the power demand of the electric consumer is greater than an adjustment threshold value.

12. The method as recited in claim 11, wherein the electric load is an assembly of an air conditioning system, an electric motor of a power steering system or an actuator of another vehicle system.

13. A control unit for assisting a driver of a vehicle when starting the vehicle facing uphill, comprising:
means for automatically actuating a brake to hold the vehicle at a standstill if the vehicle is detected to be at a standstill on a hill having a gradient exceeding a predetermined threshold;
means for automatically releasing the brake upon detection of a start command for the vehicle if one of an engine torque or a selected variable substantially equivalent to the engine torque exceeds a specified release threshold value;
means for monitoring a change in the one of the engine torque or the selected substantially equivalent variable; and
means for adjusting the release threshold value upon detection of a change in the one of the engine torque or the selected substantially equivalent variable not based on the actuation of the accelerator.

14. A computer-readable storage medium storing a computer program including program codes which, when executed by a computer, control a method for assisting a driver of a vehicle when starting the vehicle facing uphill, the method comprising:
automatically actuating a brake to hold the vehicle at a standstill if the vehicle is detected to be at a standstill on a hill having a gradient exceeding a predetermined threshold;
upon detection of a start command for the vehicle, automatically releasing the brake if one of an engine torque or a selected variable substantially equivalent to the engine torque exceeds a specified release threshold value;
monitoring a change in the one of the engine torque or the selected substantially equivalent variable; and
upon detection of a change in the one of the engine torque or the selected substantially equivalent variable not based on the actuation of the accelerator, adjusting the release threshold value.
